(19) United States
(12) Patent Application Publication
(10) Pub. No.: US 2014/0202643 A1
(43) Pub. Date: Jul. 24, 2014

(54) LIGHT CONTROL PANEL

(71) Applicants: Rifat Ata Mustafa Hikmet, Eindhoven (NL); Ties Van Bommel, Horst (NL); Wilhelmus Johannes Hendricus Ansems, Eindhoven (NL); Cornelis Eustatius Timmering, Eindhoven (NL); Jacobus Johannes Van Glabbeek, Veldhoven (NL)

(72) Inventors: Rifat Ata Mustafa Hikmet, Eindhoven (NL); Ties Van Bommel, Horst (NL); Wilhelmus Johannes Hendricus Ansems, Eindhoven (NL); Cornelis Eustatius Timmering, Eindhoven (NL); Jacobus Johannes Van Glabbeek, Veldhoven (NL)

(73) Assignee: KONINKLIJKE PHILIPS N.V., EINDHOVEN (NL)

(21) Appl. No.: 14/237,579

(22) PCT Filed: Aug. 17, 2012
(86) PCT No.: PCT/IB2012/054197

§ 371 Date: Feb. 7, 2014

Related U.S. Application Data
(60) Provisional application No. 61/529,322, filed on Aug. 31, 2011.

(51) Int. Cl. E06B 9/40; B32B 38/00; G02B 26/02

(52) U.S. Cl. CPC E06B 9/40; G02B 26/02; B32B 38/0004
USPC 160/5; 160/310; 160/6; 160/7; 156/250

(57) ABSTRACT

Alight control panel is provided, comprising: a transmissive substrate; a transmissive electrically conductive layer arranged on a surface of said substrate; a transmissive dielectric layer arranged on said electrically conductive layer; a flexible roll-up blind attached to said dielectric layer, said flexible roll-up blind layer comprising a flexible electrically conductive layer and a flexible optically functional layer, said flexible layer having naturally a rolled configuration and being capable of unrolling in response to electrostatic force; and an optoelectronic device. The panel may be useful in various energy saving applications including smart windows for buildings or vehicles, e.g. providing an energy efficient light source or utilizing solar radiation for energy conversion.

### FIELD OF THE INVENTION

The present invention relates to the field of light control using electrically controlled thin film roll-up blinds.

### BACKGROUND OF THE INVENTION

Daylight entering a house or building is traditionally controlled using window roll-up blinds or shutters that are operated manually or by motors. Where windows must keep a certain degree of transparency, for example in vehicles, permanently shaded (tinted) windowpanes are often used to reduce light and heat transmission. Energy saving aspects of daylight control for buildings and vehicles is today also becoming increasingly important. For example, in order to reduce the energy spent on climate control, it is desirable to allow control of the amount of sunlight and heat entering a building though the windows. It is also desirable to be able to control the amount of light and/or heat exiting a building.

In recent years, so-called smart windows have been developed, which allow light transmission control using for example electrochromic layers, liquid crystals or suspended particles. Smart windows are capable of switching from a transmissive state to a partially blocking or reflective state. However, smart windows using electrochromic layers have a colored appearance, which may be undesirable for many applications. Furthermore, suspended particle devices suffer from low transparency in the “open” state, due to light absorption by the particles also in the aligned state.

U.S. Pat. No. 7,684,105 discloses a microblind system having an array of overhanging stressed microblinds attached to a substrate. The microblinds have a mobile portion that is responsive to electrostatic forces to mutate between a deployed configuration in which it obscures the substrate and a curled configuration in which it exposes the substrate. The various layers of the microblinds and/or the substrate may have various optical characteristics. Although claimed to be invisible, the microblinds described in U.S. Pat. No. 7,684,105 result in unacceptably low transparency in the curled configuration, and they may not be suitable for large-scale production.

Hence, in spite of recent advances in the field of smart windows, the remains a need for improved techniques to provide shade and save energy.

### SUMMARY OF THE INVENTION

It is an object of the present invention to overcome this problem, and to provide energy-efficient light control devices and methods which avoid at least some of the drawbacks of the prior art.

According to a first aspect of the invention, this and other objects are achieved by a light control panel, comprising:

a transmissive substrate;

a transmissive electrically conductive layer arranged on a surface of said substrate;

a transmissive dielectric layer arranged on said electrically conductive layer;

a flexible roll-up blind attached to said dielectric layer, said flexible roll-up blind comprising a flexible electrically conductive layer and a flexible optically functional layer, said flexible layer having naturally a rolled configuration and being capable of unrolling in response to electrostatic force; and

an optoelectronic device.

In particular, the panel may comprise a plurality, typically one or more arrays, of said roll-up blinds and a plurality of optoelectronic devices.

The panel according to the invention may be used in various energy saving applications. For example it may be suitable for energy saving windows, which efficiently adjust the transmittance of light through a window into a house, a building or a vehicle to avoid energy spending on cooling or heating the interior, combined with an energy efficient light source or harvesting solar energy.

The flexible roll-up blind is typically separated from the electrically conductive layer by said dielectric layer. The flexible roll-up blind layer may be a stressed layer and the rolled configuration due to inherent stress in said flexible roll-up blind.

In embodiments of the invention the flexible optically functional layer may comprise a polymeric material, preferably selected from poly(methyl methacrylate), poly(ethylene terephthlate), poly(ethylene naphthalate), and combinations thereof.

Such materials can be produced as flexible thin films and can be adapted to have suitable optical properties.

Typically, the optoelectronic element may be arranged in optical contact with said substrate and/or said optically functional layer. In such embodiments of the invention, either the substrate or the optically functional layer may function as a waveguide, guiding light to or from the optoelectronic element.

In embodiments of the invention, the optically functional layer may comprise at least one wavelength converting material. Optionally the optically functional layer may comprise reflective elements, for example in the form of scattering elements dispersed throughout the layer, or as discrete reflective domains located on a surface of the optically functional layer. Furthermore, the optically functional layer may exhibit wavelength dependent reflection of incident light.

The optoelectronic device may comprise at least one light-emitting element, such as an LED, typically arranged to emit light into said substrate or into said optically functional layer. Preferably the panel comprises a plurality of optoelectronic devices, for example a plurality of LEDs.

In other embodiments, the optoelectronic device may be a photovoltaic cell comprising a light active layer arranged in optical contact with the optical functional layer.

In a second aspect, the invention relates to a window comprising a light control panel as described herein. The light control panel may be connected to one or more controllers, such as a light sensor, a temperature sensor and/or a time controller. Thus, the invention also relates to a light control system comprising a light control panel or a window as described herein, further comprising at least one (e.g. two or more) voltage source and one or more controllers for controlling the operation of the roll-blind and/or the optoelectronic device, optionally comprising a light sensor, a temperature sensor and/or a time controller.

In another aspect, the invention provides a light control system comprising a light control panel or a window as described herein, further comprising at least one voltage source and one or more controllers for controlling the operation of the roll-blind and/or the optoelectronic device, optionally comprising a light sensor, a temperature sensor and/or a time controller.

In a further aspect, the invention relates to a method of manufacturing a light control panel comprising a plurality of flexible roll-up blinds, comprising

arranging a transmissive electrically conductive layer on a transmissive substrate;

arranging a transmissive dielectric layer to cover said transmissive electrically conductive layer;

depositing an adhesive material on portions of said transmissive dielectric layer;

arranging a flexible film on said adhesive material and said dielectric layer, said flexible film comprising a flexible electrically conductive layer and a flexible optically functional layer, and said flexible layer having naturally a rolled-up configuration and being capable of unrolling in response to electrostatic force;

curing said adhesive material;

cutting the flexible film in areas between said portions comprising adhesive material to produce said plurality of flexible roll-up blinds; and

arranging an optoelectronic device on said substrate or on at least one of said flexible roll-up blinds.

Said optoelectronic device is preferably arranged in optical contact either with the substrate or the optically functional layer. Where the optoelectronic device is arranged on a flexible roll-up blinds, it is typically arranged on the optically functional layer on a region of the roll-up blind where it is attached to the dielectric layer and thus does not curl.

It is noted that the invention relates to all possible combinations of features recited in the claims.

### BRIEF DESCRIPTION OF THE DRAWINGS

These and other aspects of the present invention will now be described in more detail, with reference to the appended drawings showing embodiment(s) of the invention.

FIG. 1a-b are schematic side views of a light control panel according to embodiments of the invention.

FIG. 2a-c are schematic cross-sectional side views of a roll-up blind of the panel according to embodiments of the invention.

FIG. 2d-e are perspective views of part of a panel according to embodiments of the invention.

FIG. 3a-c are schematic side views of panels using a light source according to embodiments of the invention.

FIG. 4a-b are schematic side views of panels using a light source according to other embodiments of the invention.

FIG. 5a-c are schematic side views of panels using a photovoltaic device according to embodiments of the invention.

FIG. 6a-b are schematic side views illustrating various embodiments of the panel.

FIG. 7a-c are schematic front views illustrating various appearances of the panel in use.

### DETAILED DESCRIPTION

The present inventors have found that light control panel as described below can advantageously be used in windows etc. for combined light transmission control and energy saving.

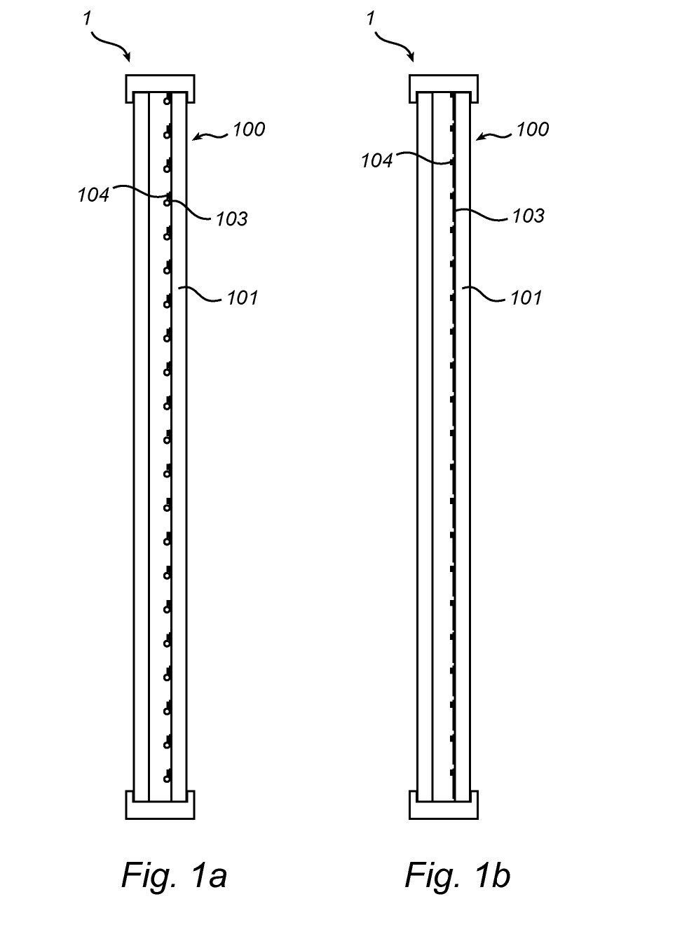

FIGS. 1a-b illustrate a light control panel comprising an array of electrically controllable thin film roll-up blinds. The light control panel 100 of this embodiment forms part of a double glaze glass window 1. The panel 100 comprises a transmissive substrate 101, typically a glass plate, on which is arranged a plurality of thin film roll-up blinds 103. Each roll-up blind 103 has a naturally rolled-up configuration and may be reversibly unrolled (FIG. 1b) in response to the application of an electric potential. In the unrolled, planar configuration (FIG. 1b) the roll-up blind 103 covers a larger part of the substrate 101 compared to its rolled-up configuration and the roll-up blind 103 itself is maximally exposed e.g. in order to receive incident radiation. When the electric potential is removed, the roll-up blind 103 reassumes its original rolled-up configuration. Further, a plurality of optoelectonic devices 104 are arranged on the substrate 101, possibly on the blinds 103. The optoelectronic devices may for example comprise light sources, serving to emit light via the roll-up blinds 103. Alternatively or additionally, the optoelectronic devices may comprise photovoltaic cells, adapted to receive incident light via the roll-up blinds 103 and convert the light into electrical energy.

As used herein, “transmissive” refers to the capability of transmitting at least some wavelengths of electromagnetic radiation. A transmissive object may be at least partly translucent, or completely transparent. Furthermore, “light transmissive” refers particularly to the capability of transmitting visible electromagnetic radiation and optionally also other wavelengths. A light transmissive object has at least some degree of translucency. “Infrared transmissive” or “IR transmissive” refers to the capability of transmitting electromagnetic radiation of the infra red wavelength range, i.e. heat radiation. An object that is IR transmissive is not necessarily light transmissive, but may be so, and thus may or may not be translucent or transparent.

As used herein, “light” refers to visible light, i.e. electromagnetic radiation in the wavelength range of about 400 nm to about 740 nm. “Infrared” or “IR” refers to electromagnetic radiation of wavelengths longer than about 700 nm, typically longer than 750 nm.

As used herein, “roll-up blind” refers to a flexible layer or film which is reversibly mutatable between a rolled-up configuration, and an at least partially unrolled (typically planar) configuration capable of covering an underlying surface. In the present specification “blind” is not intended to refer to impaired visibility or impaired light transmission in general, although the flexible optically functional layer of the roll-up blind may optionally have light reflective, light absorbing or light guiding properties.

As used herein, “optoelectronic device” refers to semiconductor devices employing quantum mechanical effects of light, using or producing light. Examples of optoelectronic devices include photovoltaic devices (e.g. solar cells and other photodiodes), laser diodes and light emitting diodes (also including organic light emitting diodes).

As used herein, “optical contact” refers to a path of light extending from one object to another object where said objects are in optical contact. “Direct optical contact” is intended to mean that said path of light extends from the first object to the second object without having to pass through an intermediate medium such as air or an optical element. As illustrated in the figures, the sizes of layers, regions and domains etc. may be exaggerated for illustrative purposes and, thus, are provided to illustrate the general structures of embodiments of the present invention.

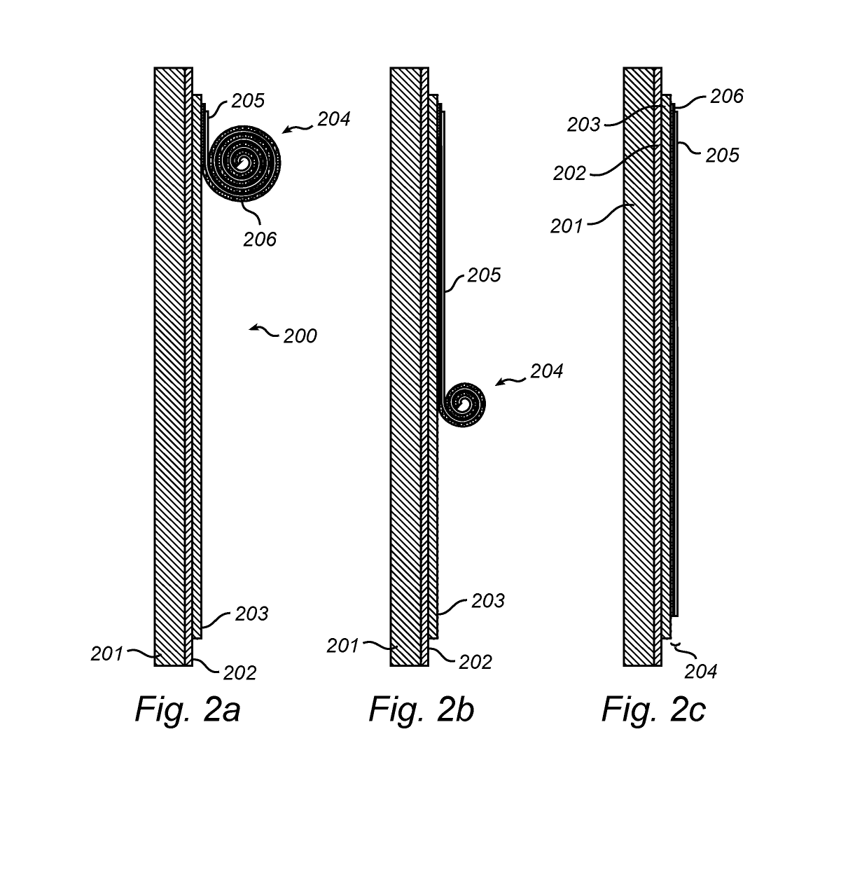

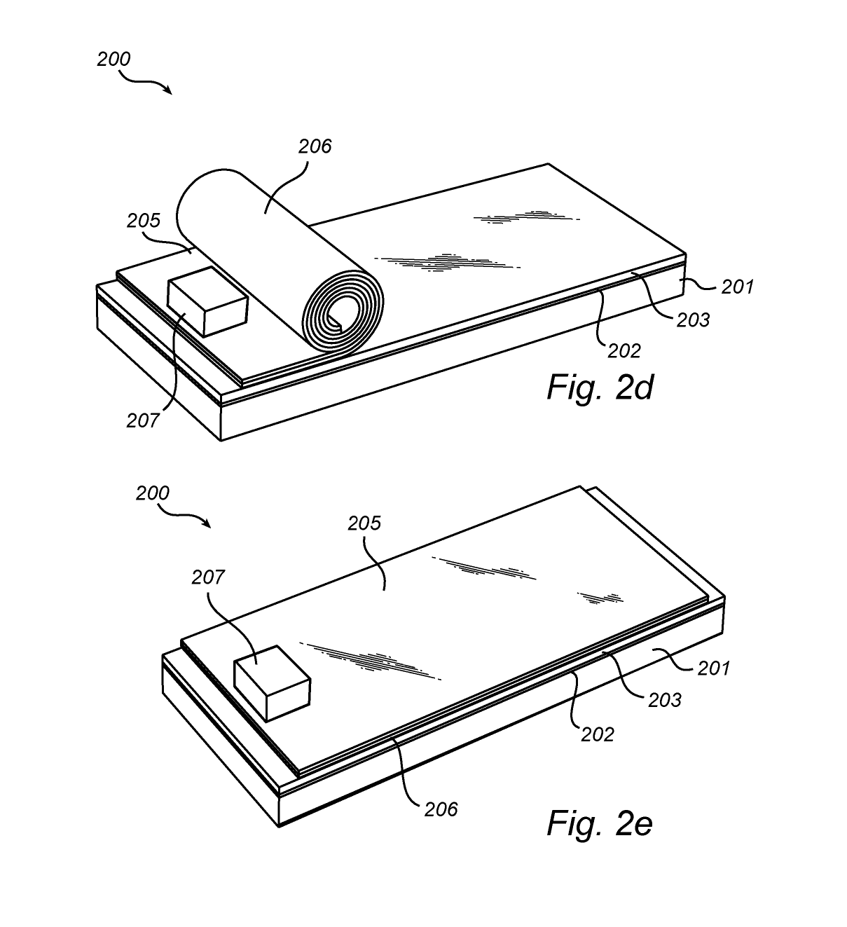

FIGS. 2a-c illustrate in more detail the structure of the panel 100 and the unrolling mechanism. FIG. 2a shows a part of a panel 200 comprising a substrate 201 on which is arranged a first electrode layer 202 connected to a voltage source (not shown). An insulating dielectric layer 203 is arranged over the electrode 202 to cover the electrode 202 and to spatially separate it from the roll-blind 204. The roll-blind 204 comprises a flexible optically functional layer 205, typically formed of a self-supporting film. On the side of the roll-up blind 204 intended to face the dielectric layer 203, the electrode 202 and the substrate 201, the optically functional layer is coated with a second electrode layer 206, which may also be connected to the voltage source.

The roll-up blind 204 assumes its natural rolled-up configuration due to elastic forces resulting e.g. from inherent stress. The stress could result from different thermal expansions coefficients of the materials of the optically functional layer 205 and the electrode layer 206, respectively, or could be induced by the fabrication (e.g. layer deposition) method, for example as indicated in U.S. Pat. No. 7,684,105.

Upon application of an electric field between the first electrode 202 and the second electrode 204, the roll-up blind 204 unrolls due to electrostatic force and thus assumes a stretched, planar position over the dielectric layer 203, as illustrated in FIGS. 2b and 2c. When the electric field is removed (voltage is switched off), the electrostatic force is eliminated and the roll-up blind 204 reverts to its curled position, illustrated in FIG. 2a, due to inherent stress as described above.

In a one embodiment, the optically functional layer 205 is a film of poly(ethylene terephthalate) (PET), and the second electrode layer 206 is an aluminum layer, which is also thin enough to be flexible. The different thermal expansion coefficient of these materials may contribute to the elastic force that causes the roll-up blind 204 to curl. The roll-up blind maintains a rolled-up (curled) position also when the panel 200 is vertically oriented, as in many window applications.

It may be assumed that three (or four) forces determine the behavior of the roll-up blind 204, which forces are the elastic force, and the electrostatic force, but also van der Waals force and to a minor extend the gravitational force. The elastic force may be a result of e.g. shrinkage during manufacturing. The elastic force acts on second electrode 206 even when there is no electric field present. By applying a voltage between or across first electrode 202 and the second electrode 206, an electrostatic force directed to unroll the roll-up blind 204 comprising the second electrode 206 and keep it in the unrolled state, is obtained. The electrostatic force is the attractive force between first and second electrodes 202 and 206 obtained by applying said voltage. The van der Waals force is the force between the dielectric material 203 and the roll-up blind 204. This force depends on the distance between the two media, the roughness of the media and the material properties; the smaller distance the larger “van der Waals” force. Finally, the gravitational force acts upon roll-up blind 204 which also depends on its orientation. In general, roll-up blind 204 may be very thin and therefore have a very low mass, and accordingly the gravitational force may be negligible.

To unroll (activate) the roll-up blind 204 and to maintain it in its unrolled state, the elastic force, which always acts on the roll-up blind 204 and is directed at rolling or curling it, must be overcome. For this purpose, a sufficient electrostatic force must be generated, and may be obtained by applying an adequate voltage between the transmissive first electrode layer 202 and the second electrode layer 206. To return the unrolled roll-up blind 204 (FIG. 2c) to its rolled (deactivated) state (FIG. 2a), the voltage is eliminated so that the electrostatic force no longer acts on the roll-up blind 204. The elastic force then causes the roll-up blind 204 to reassume it rolled-up state, under condition that the elastic force it greater than the van de Waals force.

FIGS. 2d-e illustrate in a perspective view the panel 200, comprising the substrate 201, the electrode layer 202, the dielectric layer 203, the roll-up blinds composed of electrode layer 206 and the optically functional layer 205, and also shows the optoelectronic device 207 arranged on top of the optically functional layer 205 near the edge thereof.

The panel according to the invention may operate in many different ways to create a desirable indoor ambiance with respect to lighting and temperature and save energy. In some embodiments, the roll-up blinds 104, 204 may be designed to prevent incident radiation, typically sunlight and/or heat, from being transmitted through the panel. For example, the panel may be designed to absorb, reflect or convert incident radiation. In such embodiments, when the roll-up blinds are in a rolled-up position the panel may transmit electromagnetic radiation as allowed by the characteristics of the substrate 101, 201, which in the case of a conventional window pane may transmit both visible and IR radiation.

A panel according to the invention may comprise a plurality, typically one or more arrays, of said roll-up blinds and optionally also a plurality of optoelectronic devices. In such embodiments, the first electrode layer (first electrically conductive layer) may have an in-plane extension so as to cover a panel surface intended to be covered by a plurality of roll-blinds, such that a single continuous or discontinuous (patterned) first electrode layer 202 may be used to apply an electric potential over the flexible electrode layers of several roll-blinds. Alternatively, there may be an individual first electrode layer 202 for each roll-blind.

The roll-up blind 104, 204 may be a flexible sheet having dimensions in the centimeter range, for example a width in the range of from 0.5 to 20 cm and a length (unrolled) in the range of 0.5 to 20 cm. Compared to the microblinds of U.S. Pat. No. 7,684,105, the roll-up blinds of the present invention may provide considerably improved transparency, i.e. visibility through the panel, when the roll-up blinds are in a rolled state.

In the rolled state, an individual roll-up blind 104, 204 may be rolled at least one complete turn, and typically several turns. The roll-up blind may have a radius of curvature in the range of from 1 to 10 mm. Typically the radius of curvature is uniform over the entire width of the roll-up blind.

As described above, the substrate 101, 201 is typically a glass pane. However it could also be made of a plastic. The substrate may have any suitable dimensions and properties useful for the intended application of the panel. The substrate may also have optical properties, e.g. with respect to IR transmission or transparency in general, that are suitable for the intended application.

The first electrode layer 202 is an electrically conductive layer applied on the substrate 201. Preferably, the first electrode layer is transparent, or may have at least the same degree of transparency to visible light as the substrate 201. For example, the first electrode layer 202 may be made of metallic material, such as indium tin oxide (ITO) and aluminium zinc oxide, or of conductive polymers such as polyaniline and poly(3,4-ethylene dioxythiophene) poly(styrene sulfonate) (PEDOT:PSS). Optionally the first electrode layer 202 could be a patterned electrode layer.

The dielectric layer 203 electrically insulates the first electrode layer 202 from the second electrode (flexible conductive layer) 206 of the roll-up blind 204. The dielectric layer may be formed of any suitable material, for example silicon nitride or silicon oxide, or a polymeric material, such as polyimide, benzocyclobutene (BCB) and SU-8. The dielectric layer may have any suitable optical properties, and typically has at least the same degree of transparency to visible light as the substrate and the first electrode layer. Preferably the dielectric layer is transparent. The dielectric layer may have a thickness in the range of from 100 nm to 10 μm, for example in the range of from 300 nm to 1 μm.

The roll-up blinds 204 are typically adhered to the dielectric layer via adhesive portions of an adhesive material, such as cured glue. The optically functional layer 205 of the roll-up blinds 104, 204 may be formed of a self-supporting, flexible film, typically a polymer film. Examples of polymers suitable for use as the flexible optically functional layer include poly(methyl methacrylate) (PMMA), poly(ethylene terephthalate) (PET), poly(ethylene naphthalate) (PEN) and combinations thereof. The optically functional layer may have a thickness in the range of from about 0.1 to 10 μm.

In embodiments of the invention, the optically functional layer may have a refractive index in the range of from 1.3 to 1.9, depending on the material used. For example, a PMMA film may have a refractive index of around 1.4, a PET film may have a refractive index of 1.3-1.4 and a PEN film may have a refractive index in the range of from 1.65 to 1.90. With respect to its waveguiding properties, the material of the optically functional layer is typically selected based on its refractive index and with due consideration of the refractive indices of adjoining materials, such as the flexible electrode layer, and also the dielectric layer, the first electrode layer and/or the substrate.

Furthermore, the optical properties of the flexible optically functional layer may be tuned e.g. by incorporation of particulate material or by the use of additional layers, e.g. a reflective layer, or a layer with a different refractive index. For example, one or more metallic layers of e.g. aluminum or silver may be used to provide reflective properties.

In embodiments of the invention, the optically functional layer may comprise scattering particles, e.g. particles of aluminum oxide (Al₂O₃) or titanium oxide (TiO₂). Suitable particle size may be from 0.1 to 5 μm. To provide partial, diffuse reflection of incident light the optically functional layer may have a content of scattering particles in the range of from 0.1 to 10% by weight of the layer. For concentration higher than 10% by weight, substantially full diffuse reflection of light may be achieved. However, since concentrations above 10% may influence the flexibility of the functional layer, in some embodiments it might advantageous to have an optically functional layer which comprises a stack of at least two thin layers arranged in direct optical contact, wherein a first layer comprises a high concentration of scattering particles and a second layer lacks scattering particles.

Alternatively, in embodiments of the invention, the optically functional layer may comprise light absorbing pigment such as light absorbing particles dispersed in the optically functional layer or light absorbing molecules molecularly dissolved in the optically functional layer. To provide specularly reflective properties, the optically functional layer may comprise a thin reflective metal layer, such as aluminum. For full specular reflection, an aluminum layer having a thickness of 60 nm or more may be used. Furthermore, the optically functional layer may comprise light filters for providing wavelength dependent reflection.

In some embodiments the optically functional layer may comprise a wavelength converting material that converts part of the incident light to light of a different, usually longer, wavelength. Incorporation of a wavelength converting material into the optically functional layer may be advantageous both when the panel comprises light emitting element and when it comprises photovoltaic devices, as explained above. Examples of wavelength converting materials that can be used in the optically functional layer include conventional organic and inorganic wavelength converting materials, such as inorganic phosphors, quantum dots (QDs) and organic luminescent materials such as perylene-based materials, e.g. Lumogen® Red F 300 or F Red 305 (commercially available from BASF).

The optically functional layer may optionally be patterned with light absorbing and/or diffusing and/or specularly reflective material in order to produce visual effects, such as graphics, text or images when the roll-up blinds are in an unrolled (planar) position.

The flexible electrically conductive layer 206 may be a metallic layer, e.g. indium tin oxide (ITO), aluminium or silver. The thickness of the layer 206 may be in the range of 10 nm to 1 μm, and provides flexibility to the layer. When the roll-up blind 204 is intended to be reflective, it may be advantageous to use an aluminum layer as the second flexible electrode layer, since this would reduce the need for additional reflective layers. It is contemplated that the flexible electrode layer may be a discontinuous (patterned) layer, e.g. consisting of thin lines, a grid, etc. However, it is preferred that the flexible electrode layer at least has a length corresponding to the length of the optically functional layer, to provide conductivity along its entire length.

In embodiments of the invention, the optoelectronic devices 104, 207 may be solid state light sources, typically LEDs. A light control panel comprising roll-up blinds 103 and light sources 104 may be designed to have various light-emitting functions and applications.

The solid state light source used in embodiments of the invention may comprise a light emitting diode (LED), an organic light emitting diode (OLED), or a laser diode.

For example, in some embodiments, the panel 100 may function as an ordinary window glass panel during the day, the roll-up blinds 103 being rolled up, transmitting light and optionally IR radiation to the interior of a room, a building or a vehicle. When daylight is poor or absent, LEDs 104 may be turned on to provide additional lighting. Optionally, some or all of the roll-up blinds 103 may then be unrolled to prevent light leakage to the exterior. Thus, the panel may function as a light-emitting window towards the interior of a room or a building, while allowing little or no light to escape to the exterior. Hence, it may be a very energy efficient light source.

The light sources are connected to one or more controllers and may be operable independently of the roll-up blinds 104.

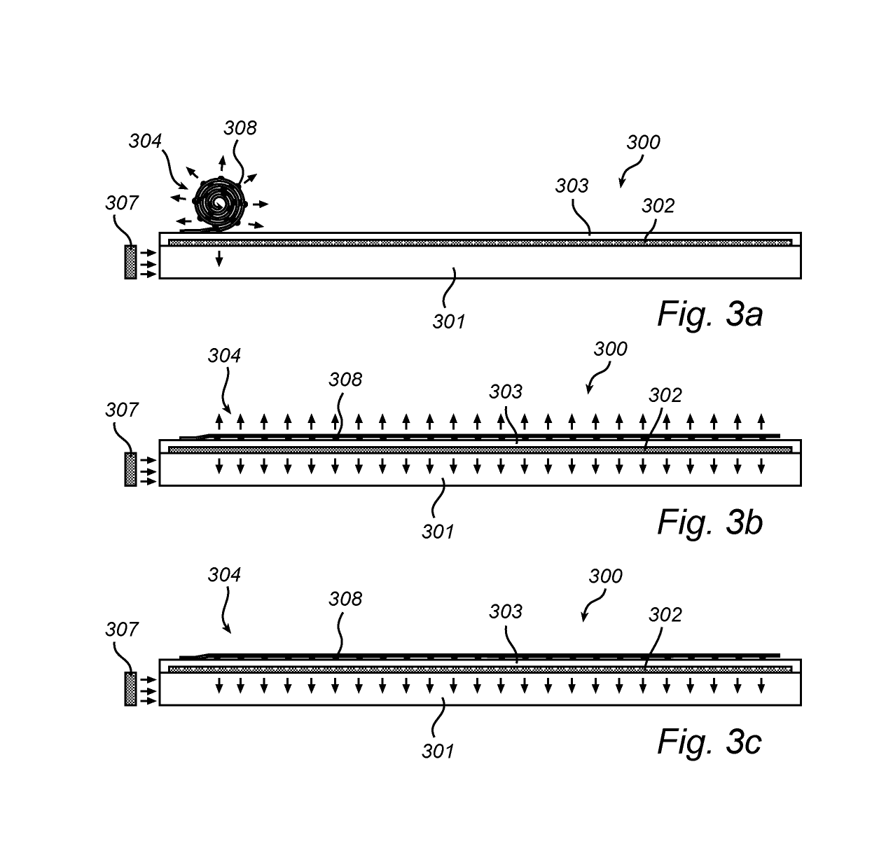

FIG. 3a-c illustrate another embodiment of the invention using a light source for the optoelectronic device. The panel 300 comprises a light source 307, here an LED, which is arranged in optical contact with the substrate 301. On the substrate 301 is arranged a transmissive electrode layer 302 and a transmissive dielectric layer 303 as described above. The roll-up blind 304 comprises a second electrode layer and an optically functional layer as described above. In this embodiment the flexible second electrode and/or the flexible optically functional layer may be at least partially light transmissive. The roll-up blind 304 further comprises a plurality of light extracting elements 308 arranged on the side of the second electrode facing the substrate 301. Hence, when the roll-up blind 304 is unrolled, the light extracting elements contact the dielectric layer 303.

The LED 307 is arranged to emit light into the transmissive substrate 301, which in this embodiment functions as a waveguide. Light emitted by the LED may thus be waveguided inside the substrate 301 and the electrode layer and the dielectric layer due to total internal reflection until incident upon a light extracting structure, such as the light extracting elements 308 provided on the roll-up blind 304. The light incident on the light extracting element 308 may be either transmitted by the light extracting element and then further transmitted though the unrolled roll-up blind 304 so as to result in light emission from the side of the panel 300 carrying the blind, or the light may reflected by the light extracting element 308 at such reflection angle that it may subsequently escape from the substrate 301, resulting in light emission from the substrate side of the panel 301, see FIG. 3b.

In embodiments of the invention, as illustrated in FIG. 3c, the roll-up blind 304 may be reflective. Typically, the reflective property may be due to the second electrode layer being reflective. In such embodiments, no light is typically emitted from the side of the panel carrying the roll-up blinds, but instead substantially all light is emitted via the “substrate side” of the panel 300. In other embodiments, the roll-up blind 304 may be adapted to reflect light of a certain wavelength range (e.g., blue light) while transmitting light of another wavelength range. For example, the roll-up blind may function as a dichroic mirror. As a result, light of a first wavelength range may be emitted from the substrate side of the panel, while light of a second wavelength range is emitted from the side of the panel carrying the roll-up blinds. Hence, the panel may emit light of different colors from different sides.

Alternatively, it is envisaged that light extraction elements could be arranged on the dielectric layer 203 instead of, or in addition to, the light extraction elements provided on the roll-up blind 304. Hence, the panel may allow extraction of light, and thus light emission from both sides of the panel, also in the rolled-up state of the roll-up blind 304.

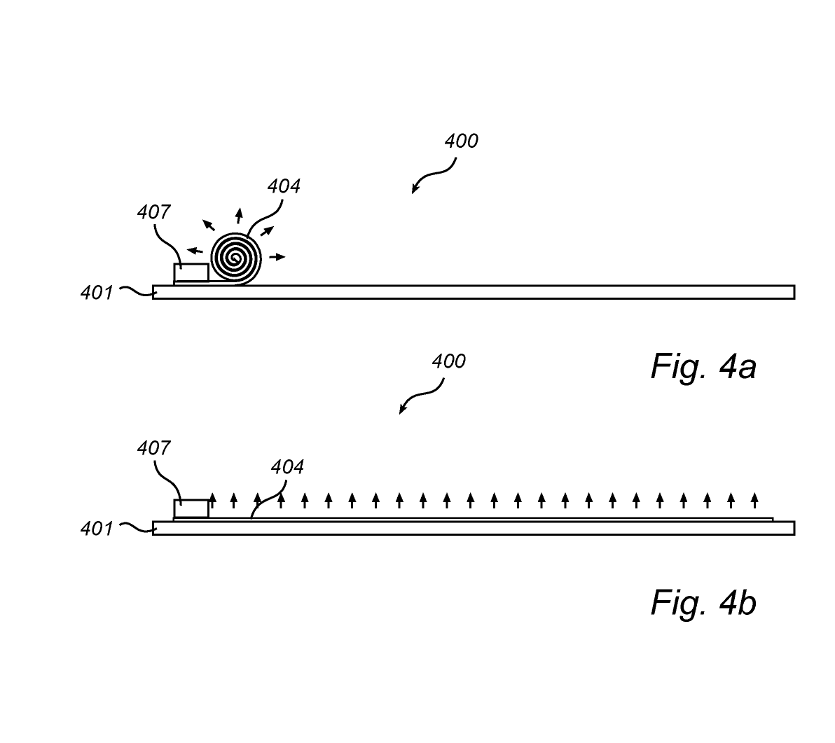

In a further embodiment illustrated in FIG. 4a-b, a light source 407 (typically an LED) is arranged to emit light into the optically functional layer of the roll-up blind 404 instead of into the substrate 401. For this purpose, the light source may be adhered, typically using optical glue, on a portion of the roll-up blind that is always planar, typically an anchoring portion at which the roll-up blind 404 is attached to the dielectric layer of the substrate. In this embodiment, the light source 407 emits light directly into the optically functional layer which acts as a waveguide. As a result, when the roll-up blind is unrolled, the panel may emit light from the surface area covered by the roll-up blind 404 (FIG. 4b).

To provide improved incoupling of light from the light source into the light guide (i.e., the roll-up blind), one or more incoupling elements may be provided. For example, a diffuse reflector may be positioned at the opposite side of the substrate compared to the position of the roll-up blind and the light source, in direct optical contact with the substrate and aligned with the light source. In this way, light from the light source that is not coupled into the light guide may be diffusely reflected back by the diffuse reflector such that a higher fraction of light is coupled into the light guide.

In some embodiments, the roll-up blind 404 may be at least partly transmissive to light incident on its unrolled surface, such as ambient light. Hence, it the may transmit daylight while also emitting light. In other embodiments, the roll-up blind 404 may be partly reflective. Optionally, the second electrode layer of the roll-up blind 404 may provide a reflective surface, e.g. to reflect ambient light that is incident via (transmitted by) the substrate 401. Hence, a light emitting window is provided in which each light source 407 is integrated with and functionally coupled to a roll-up blind 404.

In embodiments of the present invention where the optoelectronic device is a solid state light source, the light source may be an LED-based light source. The light source is typically a conventional LED, adapted to emit white light, for example blue, ultra-violet or violet LED combined with a suitable wavelength converting material. Alternatively, the light source may be an LED which emits a specific color such as red, green or blue, optionally in combination with a suitable wavelength converting material. Direct phosphor converted LEDs or LEDs in combination with phosphor in the remote configuration may be used.

In some embodiments, in particular when using a blue LED as a light source, a luminescent material may be comprised in the optically functional layer 205 of the roll-up blinds 204. Hence, the roll-up blind 404 may act as a waveguide for blue light emitted by the LED and also as a conversion element, converting part of the blue light into light of longer wavelengths, typically the yellow, orange and/or red wavelength ranges of the visible spectrum. The total light emitted from the panel may be white light. It is contemplated that some roll-up blinds may comprise a first luminescent material, converting light from associated LEDs into one wavelength range, while other roll-up blind may comprise a different luminescent material, converting light from associated LEDs into light of a different wavelength range. It is also contemplated that only some roll-up blinds of the panel may comprise a wavelength converting material, and other roll-up blinds may lack a wavelength converting material.

In embodiments where the optoelectronic device comprises a plurality of light sources, e.g. LEDs, the light sources may be provided on the opposite side of the substrate compared to the roll-up blinds, and may be arranged to emit light in the direction away from the substrate 101 and the roll-up blinds 104. Alternatively, the light sources may be provided on a substrate plate separate from the substrate 101 carrying the roll-up blinds 104. In other embodiments, as illustrated in FIGS. 1, 3 and 4, the light source may be in optical contact with the substrate and the roll-up blind, each light source arranged to emit light into the substrate or into the optically functional layer of a roll-up blind. Typically one light source is arranged on each roll-up blind.

A plurality of light sources may be interconnected to form a group of light sources, and may be operable independently of another group of light sources. An individual light source may be operable independently or co-dependently of a roll-up blind to which it is coupled.

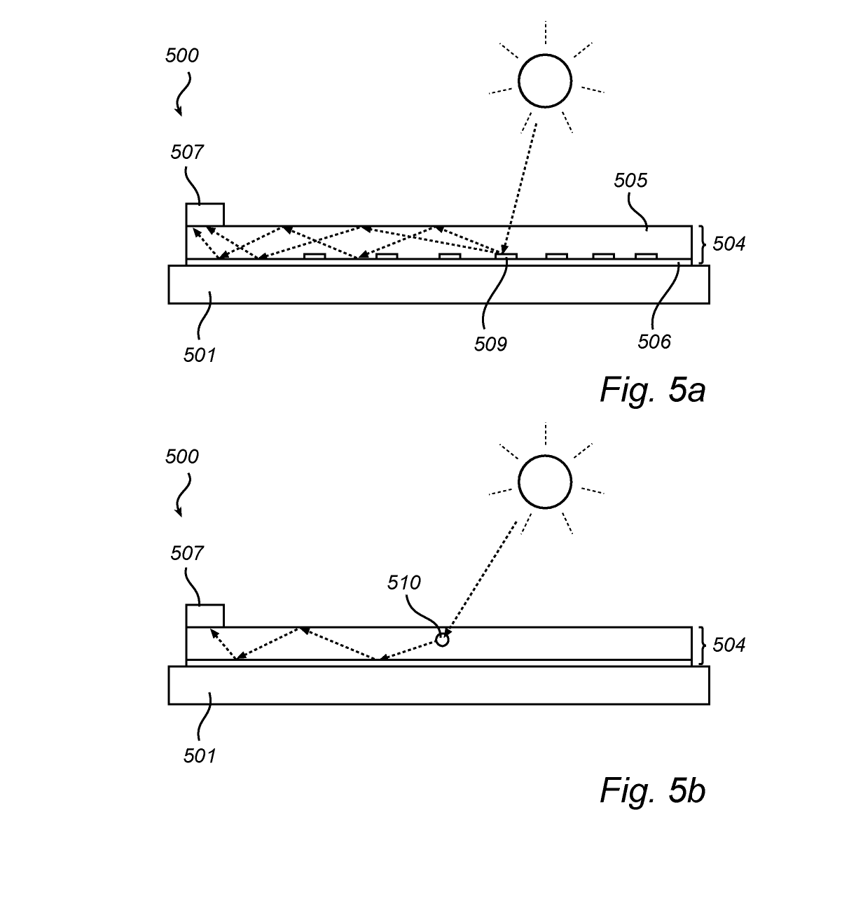

In embodiments of the present invention illustrated in FIG. 5a-b, the optoelectronic device is a photovoltaic cell (solar cell). Typically, the panel comprises a plurality of photovoltaic cells. Such panels may be useful e.g. in window applications, shielding the interior of a building from strong sunlight while at the same time utilizing the solar energy for generating electricity.

As illustrated in FIG. 5a, the panel 500 comprises a photovoltaic cell 507 arranged in optical contact, preferably in direct optical contact, with the optically functional layer of a roll-up blind 504. For example the photovoltaic cell may be arranged on a portion of the blind, in contact with the optically functional layer 505. The portion where the photovoltaic cell is arranged may be an anchoring portion, where the roll-up blind 504 on the side thereof opposite to the photovoltaic cell is adhered, typically using optical glue, to the dielectric layer of the substrate 501. An alternative arrangement is shown in FIG. 5c. In this arrangement, a photovoltaic device 507 is arranged in contact with the lateral surface 513 of the roll-up blind 504 and receives light guided by the roll-up blind. Advantageously, an edge portion 511 of the optically functional layer of the roll-up blind 504 has an increased thickness compared to the rest of the optically functional layer, and a tapering portion 514 between the edge 511 and the planar portion 512 forming the major part of the roll-up blind in the unrolled state. Hence, the enlarged lateral surface 513 of the optically functional layer is provided.

The photovoltaic cell may be any conventional photovoltaic cell that can be made small enough to fit on or next to the roll-up blinds. Suitably an individual photovoltaic cell may have a length of from 0.5 to 20 cm, and a width of from 0.5 to 20 cm. The thickness of the photovoltaic cell may be in the range of from 20 μm to e.g. 3 mm. For example, flexible CIGS solar cells, which may be advantageous in the present invention, may have a thickness of about 30 μm.

Since the photovoltaic cell absorb light also in the rolled-up (inactive) state of the roll-up blinds, the presence of photovoltaic cells may reduce the transparency of the panel in the rolled-up state. It may therefore be advantageous that the photovoltaic cells only cover a minor part of the total area of the light control panel.

The photovoltaic cell may be controllable independently of the roll-up blind 504.

In embodiments employing a photovoltaic cell, the optically functional layer may operate as a waveguide, receiving incident light and guiding it to the photoactive layer of the photovoltaic device which converts light into electrical energy. In some embodiments, the roll-up blind 504 may comprise discrete reflective domains 509 arranged between the optically functional layer and the dielectric layer (as seen in the unrolled state). For example the reflective domains may comprise a scattering material such as reflective particles or particles with a large refractive index mismatch. Optionally the reflective domains may have a surface roughness to increase scattering.

FIG. 5b illustrates another embodiment in which the roll-up blind 504 also functions as a waveguide for guiding incident light to the photoactive layer of the photovoltaic device. In this embodiment, the optically functional layer comprises a wavelength converting material 510, which serves to convert part of the incident light into light of different wavelength distribution that may be more efficiently in coupled and guided and/or more efficiently used by the photovoltaic cell for conversion into electrical energy. In this embodiment, the roll-up blind 504 may optionally also comprise reflective domains 509.

In some embodiments using photovoltaic devices, the roll-up blinds 504 may be reflective with respect to IR radiation. Hence, when exposed to strong sunlight some or all of the roll-up blinds 504 may be unrolled, thus shading e.g. the interior of a building, while also harvesting the solar energy for conversion to electrical energy. Thus electrical energy may be produced from a renewable source while also reducing the need for cooling the interior of the building. In poor daylight or at night, the panel may function as an ordinary transparent or translucent window, the roll-up blinds being rolled up.

In some embodiments, the panel may combine the use of light sources and photovoltaic devices, for example a panel which provides shade and produces electrical energy during bright days, and which may also be used as a light-emitting panel as described above, for example at night. In such embodiments, some roll-up blinds may be waveguiding and optically coupled to a light source and/or a photovoltaic cell as described above. The roll-up blinds may in such cases be arranged on the same side of the substrate, or on different sides thereof.

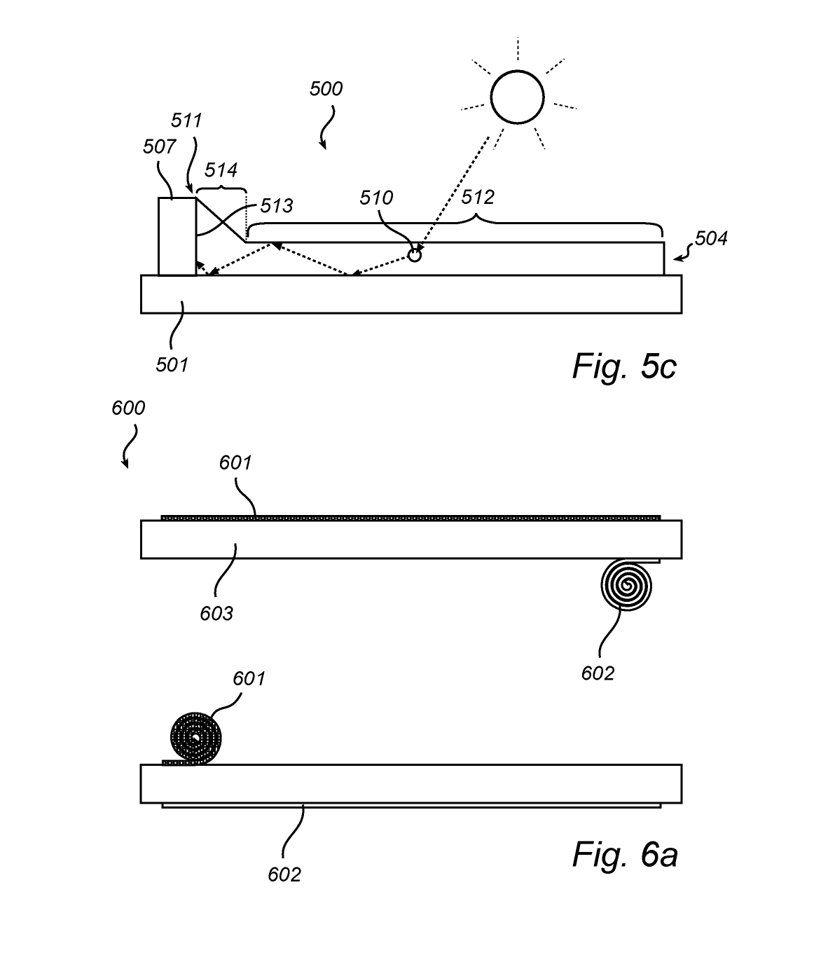

For example, as illustrated in FIG. 6a, a combination panel 600 may comprise roll-up blinds 601, 602 arranged on opposing surfaces of a substrate 603. Each roll-up blind 601, 602 comprises a flexible electrode layer and an optically functional layer as described above and is each associated with a first electrode layer with a dielectric layer as described above, for controlling the activation of the roll-up blind by application of a voltage. The roll-up blind 601 may be optically coupled to a solar cell (not shown) as described above, while the roll-up blind 602 may be optically coupled to a light source e.g. as described above in relation to FIGS. 3 and 4. Thus, in strong daylight, the roll-up blinds 601 may be activated (unrolled) and the panel may be used for converting solar energy into electrical energy while providing shade. When daylight is too poor for lighting purposes, the roll-up blinds 601 may be deactivated (i.e. in the rolled state) and instead the roll-up blinds 602 may be activated (unrolled) to provide light emission. When daylight is neither too strong nor too weak, both roll-up blinds 601 and 602 may be deactivated (rolled-up).

FIG. 6b shows an alternative arrangement generally serving the same purpose as the panel of FIG. 6a. In FIG. 6b, the roll-up blinds 601, 602 are arranged each on a separate substrate, forming for example a double glazed window.

It is understood that a panel according to the embodiments of the invention described herein, for example with reference to FIGS. 1-6, typically comprises a plurality of roll-up blinds and optoelectronic devices arranged in arrays or any suitable pattern over the entire surface of the panel, or on part of a surface of the panel, or on part or all of several surfaces of the panel. It is also contemplated that each roll-up blind may be provided as a cartridge element, such that it can be individually removed or replaced, independently of the other roll-up blinds of the panel.

The roll-up blinds may be operably connected to one or more controllers so as to be electrically controllable by an operator.

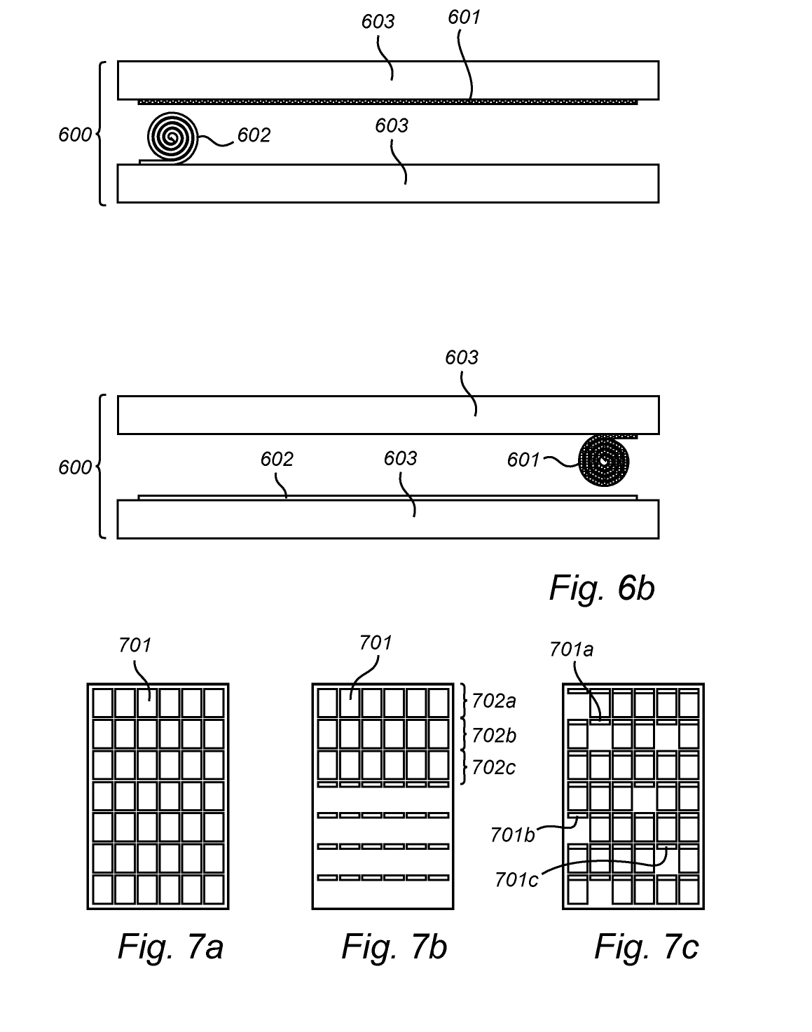

FIGS. 7a-c illustrate different effects that may be achieved by separate control of different regions of the panel. In FIG. 7a all roll-up blinds 701 are activated simultaneously to provide a light control effect over the entire panel. It is noted that the individual roll-up blinds may have different properties as described herein, and the resulting light control effect could be, but need not be homogeneous. In FIG. 7b only a few rows 702a, 702b, 702c of roll-up blinds 701 are activated, while the remaining part of the panel typically is transmissive according to the inherent properties of the substrate. The roll-up blinds 701 of an array or a row 702a, 702b, 702c may be co-dependently operable. Furthermore, in FIG. 7c all roll-up blinds are activated except a group formed of uniformly or non-uniformly distributed roll-up blinds 701a, 701b, 701c. The roll-up blinds 701a, 701b, 701c may be co-dependently operable.

Similarly, the optoelectronic device(s) may be connected to one or more controllers so as to be electrically controllable by an operator, optionally independently of the roll-up blinds.

In embodiments of the invention, the panel further comprises one or more controllers combined with a timer for time-controlling the operation of the roll-up blinds and/or the optoelectronic device, and/or one or more controllers for controlling the operation in response to ambient conditions such as ambient light and/or temperature. Hence, one or more controllers for controlling the roll-up blind(s) and/or the optoelectronic device(s) may be combined with a light sensor and/or a temperature sensor. Suitable control devices and mechanisms will be readily applied by persons skilled in the art.

The panel according to the invention may be produced as follows. An electrically conductive layer 202 as described above is deposited onto a substrate 101, 201 by conventional techniques, e.g. chemical vapor deposition (CVD), physical vapor deposition (PVD), and various coating or printing techniques. The electrically conductive layer 202 may be a patterned layer, produced by printing or by lithography.

Next, a dielectric layer 203 as described above is applied over the dielectric layer by any suitable technique, e.g. using chemical vapor deposition (CVD) or physical vapor deposition (PVD) for silicon nitride, or spin coating for a polymeric layer. Adhesive material, typically glue, is applied to portions (typically as thin lines) of the dielectric material intended to form anchoring regions for the individual roll-up blinds. Onto the dielectric layer and the adhesive portions is applied a continuous film 205 of flexible polymeric material as described above, e.g. PET, which has previously been coated with a thin electrically conductive layer 206 on the side of the film intended to face the dielectric layer. The glue may then be cured. After the film has adhered via the adhesive portions, the continuous film 205 comprising the coating 206 is separated e.g. by laser cutting, between the adhesive portions to form the individual roll-up blinds 204, each adhering to the dielectric layer near one of its edges. Once separated (cut), the individual roll-up blinds curl due to inherent stress as explained above.

The optoelectronic devices, e.g. LEDs or photovoltaic devices may be produced and applied to the panel using conventional methods known in the art.

The panel according to the invention may be applied as a window pane to form a window of a building, or of a vehicle for example in automotive, marine or aerospace applications. For example, the panel may form one of the permanent panes of a double-glaze window. Alternatively, the panel may be a pane that is permanently or detachably placed between the two panes of a double-glazed window, or in front of a single-glazed or double-glazed window. In some embodiments the panel may be used as a sun roof of a car. In other embodiments, the panel may be used as an architectural feature, an interior light-emitting window or a privacy window for professional or home settings.

The person skilled in the art realizes that the present invention by no means is limited to the preferred embodiments described above. On the contrary, many modifications and variations are possible within the scope of the appended claims.

1. A light control panel, comprising:
a transmissive substrate;
a transmissive electrically conductive layer arranged on a surface of said substrate;
a transmissive dielectric layer arranged on said electrically conductive layer;
a flexible roll-up blind attached to said dielectric layer, said flexible roll-up blind comprising a flexible electrically conductive layer and a flexible optically functional layer, said flexible layer having naturally a rolled configuration and being capable of unrolling in response to electrostatic force; and
an optoelectronic device arranged in optical contact with said substrate and/or said optically functional layer,
wherein the substrate or the optically functional layer is a waveguide, capable of guiding light to or from the optoelectronic device.

2. A light control panel according to claim 1, wherein the flexible roll-up blind is separated from the electrically conductive layer by said dielectric layer.

3. A light control panel according to claim 1, wherein the flexible roll-up blind layer is a stressed layer and the rolled configuration is due to inherent stress in said flexible roll-up blind layer.

4. A light control panel according to claim 1, wherein the flexible optically functional layer comprises a polymeric material, preferably selected from poly(methyl methacrylate), poly(ethylene terephthlate), poly(ethylene naphthalate), and combinations thereof.

5-6. (canceled)

7. A light control panel according to claim 1, wherein the optically functional layer comprises at least one wavelength converting material.

8. A light control panel according to claim 1, wherein the optically functional layer comprises reflective elements.

9. A light control panel according to claim 1, wherein the optically functional layer exhibits wavelength dependent reflection.

10. A light control panel according to claim 1, wherein the optoelectronic device comprises at least one light-emitting element.

11. A light control panel according to claim 10, wherein said light-emitting element is arranged to emit light into said substrate or into said optically functional layer.

12. A light control panel according to claim 1, wherein the optoelectronic device is a photovoltaic cell comprising a light active layer arranged in optical contact with the optically functional layer.

13. A window comprising a light control panel according to claim 1.

14. A light control system comprising a light control panel according to claim 1, further comprising at least one voltage source and one or more controllers for controlling the operation of the roll-blind and/or the optoelectronic device, optionally comprising a light sensor, a temperature sensor and/or a time controller.

15. A method of manufacturing a light control panel comprising a plurality of flexible roll-up blind layers and at least one optoelectronic device, comprising
arranging a transmissive electrically conductive layer on a transmissive substrate;
arranging a transmissive dielectric layer to cover said transmissive electrically conductive layer;
depositing an adhesive material on portions of said transmissive dielectric layer;
arranging a flexible film on said adhesive material and said dielectric layer, said flexible film comprising a flexible electrically conductive layer and a flexible optically functional layer, and said flexible layer having naturally a rolled-up configuration and being capable of unrolling in response to electrostatic force;
curing said adhesive material;
cutting the flexible film in areas between said portions comprising adhesive material to produce said plurality of flexible roll-up blinds; and
arranging an optoelectronic device on said substrate or on at least one of said flexible roll-up blinds.
